(19) United States
(12) Patent Application Publication
(10) Pub. No.: US 2025/0336196 A1
(43) Pub. Date: Oct. 30, 2025

(54) PAVEMENT DISEASE DETECTION METHOD AND DEVICE BASED ON IMPROVED YOLOV9 MODEL

(71) Applicant: NANJING UNIVERSITY OF POSTS AND TELECOMMUNICATIONS, Nanjing (CN)

(72) Inventors: Dengyin ZHANG, Nanjing (CN); Wenhao LIU, Nanjing (CN); Chao ZHOU, Nanjing (CN); Yulan ZHU, Nanjing (CN); Jie JU, Nanjing (CN); Jing LI, Nanjing (CN)

(21) Appl. No.: 18/946,155

(22) Filed: Nov. 13, 2024

Related U.S. Application Data
(63) Continuation of application No. PCT/CN2024/120366, filed on Sep. 23, 2024.

(30) Foreign Application Priority Data
Apr. 26, 2024 (CN) 2024105114498

(51) Int. Cl. G06V 10/82; G06V 10/764; G06V 10/774; G06V 10/776; G06V 20/50

(52) U.S. Cl. CPC G06V 10/82; G06V 10/764; G06V 10/774; G06V 10/776; G06V 20/50

(57) ABSTRACT

The present application discloses a pavement disease detection method and device based on an improved YOLOv9 model, which includes: inputting a to-be-detected pavement disease image into a trained and improved YOLOv9 model for detecting a pavement disease to recognize the pavement disease, to obtain a detection result; a training method of the improved YOLOv9 model for detecting the pavement disease includes: obtaining a pavement disease image dataset and dividing the pavement disease image dataset into a training set and a validation set; adding an LSKNet module after a specific layer of an original YOLOv9 model to construct the improved YOLOv9 model for detecting the pavement disease; and training the constructed improved YOLOv9 model for detecting the pavement disease by the training set and the validation set to obtain the trained and improved YOLOv9 model for detecting the pavement disease.

### CROSS-REFERENCE TO RELATED APPLICATIONS

The present application claims priority to Chinese Patent Application No. 202410511449.8, filed Apr. 26, 2024, the entire disclosure of which is incorporated herein by reference.

### TECHNICAL FIELD

The present application relates to a pavement disease detection method and device based on the improved YOLOv9 model, and belongs to the field of information perception and recognition technology.

### BACKGROUND

Vision-based pavement disease detection can be collected on the road through vehicle recorders, vehicle-mounted cameras, and UAV aerial photography equipment and other acquisition equipment, which has the characteristics of low cost, high speed, high accuracy, etc., and is widely used at this stage. However, in the actual detection work, due to the complexity of the road surface, imaging is affected by lighting and other factors, leakage and misdetection occur from time to time, therefore, how to improve the recognition accuracy of pavement diseases is an important topic in the field of computer vision.

The target detection networks used to recognize pavement damage are broadly divided into two categories: one-stage target detection networks and two-stage target detection networks. One-stage target detection network has the advantages of fast speed and good real-time performance compared with two-stage target detection networks, and is suitable for industrial inspection in the field of high real-time requirements. In terms of one-stage target detection network, the series of YOLO models attract a lot of attention. Since the first generation of the model is made public, the YOLO model goes through many updates, and each generation of the updated version has better detection efficiency and accuracy than the previous one. Especially in the latest version of YOLOv9 model, it is a major breakthrough in speed and accuracy, and becomes a new SOTA model in the field of target detection. However, the YOLOv9 model still faces the problem of not being able to focus well on the key regions in learning.

The current research on how to improve the pavement disease detection accuracy based on the YOLOv9 model is still lacking.

### SUMMARY

The present application introduces the LSKNet network, which incorporates the large kernel selection module and the feed-forward network module. where the large kernel selection module can dynamically adjust the sensory field of the network according to the needs, and the feed-forward network module is used for channel mixing and feature refinement. The introduction of the LSKNet network effectively solves the problem that the model can not focus on the key regions well, and improves the detection accuracy of the pavement disease.

The purpose of the present application is to overcome the deficiencies in the related art, and provide a pavement disease detection method and device based on the improved YOLOv9 model, in order to realize the detection of pavement disease with higher accuracy.

In order to achieve the above purpose, the present application is realized by adopting the following technical solution.

In order to achieve the stated purpose, the present application is realized using the following technical solution.

In a first aspect, the present application discloses a pavement disease detection method based on an improved YOLOv9 model, including:
inputting a to-be-detected pavement disease image into a trained and improved YOLOv9 model for detecting a pavement disease to recognize the pavement disease, to obtain a detection result;
a training method of the improved YOLOv9 model for detecting the pavement disease includes:
obtaining a pavement disease image dataset and dividing the pavement disease image dataset into a training set and a validation set;
adding an LSKNet module after a specific layer of an original YOLOv9 model to construct the improved YOLOv9 model for detecting the pavement disease; and
training the constructed improved YOLOv9 model for detecting the pavement disease by the training set and the validation set to obtain the trained and improved YOLOv9 model for detecting the pavement disease.

In one embodiment, the LSKNet module is added after the specific layer of the original YOLOv9 model to construct the improved YOLOv9 model for detecting the pavement disease includes:
constructing an LSKNet module, wherein the LSKNet module includes a large kernel (LK) selection module, and a feed-forward network (FFN) module, where the LK selection module is capable of dynamically adjusting a sensory field of a network as needed, and the FFN module is configured for channel mixing and feature refinement;
adding the LSKNet module after a 16th, 19th, and 22nd RepNCSPELAN4 modules of a head network of the original YOLOv9 model, and adding the LSKNet module before a 11th SPPELAN module of a backbone network of the original YOLOv9 model, to obtain the improved YOLOv9 model for detecting the pavement disease.

In one embodiment, the LK selection module includes a sequence of fully connected layers, a gaussian error linear unit (GELU) activation function layer, a core LSK layer, and a second fully connected layer.

In one embodiment, the FFN module includes a sequence of fully connected layers, a depth convolution, a GELU activation function layer, and a second fully connected layer.

In one embodiment, the pavement disease image dataset is derived from the RDD2020 competition dataset.

In one embodiment, the pavement disease image dataset includes a plurality of categories of pavement diseases, namely Longitudinal Cracks (D00), Transverse Cracks (D10), Alligator Cracks (D20), and Potholes (D40).

In one embodiment, the detection result includes types and location information of the pavement disease.

In one embodiment, the method further includes: dividing the test set from the pavement disease image dataset, and evaluating a detection accuracy of the trained and improved YOLOv9 model for detecting the pavement disease by the test set.

In a second aspect, the present application discloses a pavement disease detection device based on an improved YOLOv9 model, which includes:
a detection module, configured for inputting a to-be-detected pavement disease image into a trained and improved YOLOv9 model for detecting a pavement disease to recognize the pavement disease, to obtain a detection result;
in the detection module, a training method of the improved YOLOv9 model for detecting the pavement disease includes:
obtaining a pavement disease image dataset and dividing the pavement disease image dataset into a training set and a validation set;
adding an LSKNet module after a specific layer of an original YOLOv9 model to construct the improved YOLOv9 model for detecting the pavement disease; and
training the constructed improved YOLOv9 model for detecting the pavement disease by the training set and the validation set to obtain the trained and improved YOLOv9 model for detecting the pavement disease.

In a third aspect, the present application discloses a computer-readable storage medium, on which a computer program is stored, wherein the program, when executed by a processor, implements any one of the methods described above.

Beneficial effects achieved by the present application compared with the related art:
(1) The detection method proposed in the present application is based on the current state-of-the-art YOLOv9 target detection algorithm, and introduces the LSKNet module, so that it has higher detection accuracy. The LSKNet module is inserted into the head network and backbone network of the YOLOv9 in the present application, so that the model can capture a wider range of contextual information in the image and improve the detection accuracy of pavement diseases.
(2) A large kernel selection module proposed in the present application for enhancing feature expression dynamically adjusts the sensory field of the network as needed to better capture and recognize irregular diseases.
(3) A feed-forward network module for feature refinement proposed in the present application can learn a higher level of feature representation to enhance the expression capability of the model, and also introduces a location-aware capability by independently transforming the features at each location, such that the model can weight the features at different locations according to the location information, and enhances the model's focus on different locations in the image.

In summary, the present application fuses a variety of advanced modules, which makes the fused network architecture more in line with the requirements of pavement disease detection. By improving the head network and backbone network of YOLOv9, it can capture a wider range of contextual information in the image, thereby enhancing the accuracy of pavement disease detection.

### BRIEF DESCRIPTION OF THE DRAWINGS

FIG. 1 is a flowchart of the present application.

FIG. 2 is a schematic diagram of the overall network structure of the present application.

FIG. 3 is a schematic diagram of the LSKNet core module in the present application.

FIG. 4 is a schematic diagram of the LSK selectivity mechanism module in the present application.

FIG. 5 is a schematic diagram of a pavement disease image in the present application.

FIG. 6 is a schematic diagram of a detection result of the pavement disease in the present application.

### DETAILED DESCRIPTION OF THE EMBODIMENTS

The present application is further described below in conjunction with the accompanying drawings. The following embodiments are only used to illustrate the technical solution of the present application more clearly, and are not to be used to limit the scope of the present application.

### First Embodiment

This embodiment describes a pavement disease detection method based on the improved YOLOv9 model, which includes:
inputting a to-be-detected pavement disease image into a trained and improved YOLOv9 model for detecting a pavement disease to recognize the pavement disease, to obtain a detection result;
a training method of the improved YOLOv9 model for detecting the pavement disease includes:
obtaining a pavement disease image dataset and dividing the pavement disease image dataset into a training set and a validation set;
adding an LSKNet module after a specific layer of an original YOLOv9 model to construct the improved YOLOv9 model for detecting the pavement disease; and
training the constructed improved YOLOv9 model for detecting the pavement disease by the training set and the validation set to obtain the trained and improved YOLOv9 model for detecting the pavement disease.

The present embodiment provides a pavement disease detection method based on the improved YOLOv9 model, which includes:

Step 1: obtaining the pavement disease image dataset and dividing the pavement disease image dataset into the training set, the validation set, and a test set. The RDD2020 competition dataset selected in the present application contains several categories of pavement diseases, but four of which the present application only focus on, namely Longitudinal Cracks (D00), Transverse Cracks (D10), Alligator Cracks (D20), and Potholes (D40). The dataset is located at: https://data.mendeley.com/datasets/5ty2wb6gvg/1.

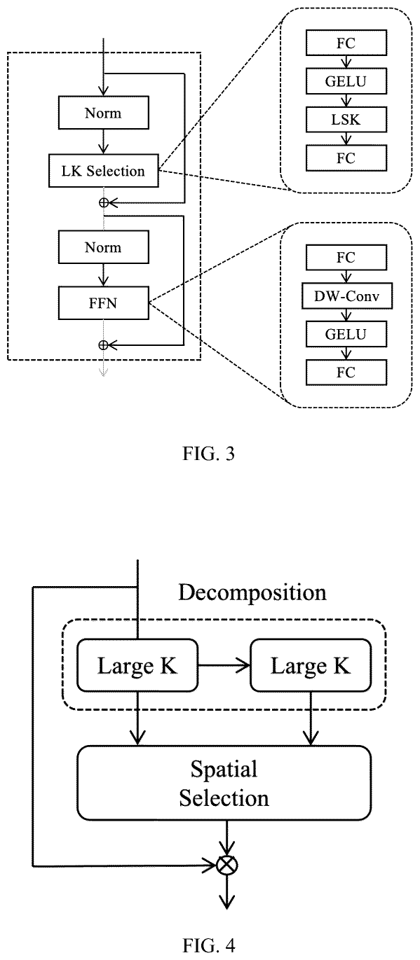

Step 2: constructing the LSKNet module. Referring to the schematic diagram of the LSKNet core module shown in FIG. 3, the LSKNet module includes a large kernel selection module and a feed-forward network module.

The large kernel selection module dynamically adjusts the sensory field of the network as needed, and consists of a fully connected layer sequence (FC), a GELU activation function layer, a core LSK layer, and a second fully connected layer. An input of the first FC module is connected to an external input and an output of the fourth FC module is summed with an input of a previous layer of the LK selection sub-block as the output.

The feed-forward network module is configured for channel mixing and feature refinement, and consists of a sequence of fully connected layers (FC), a deep convolution, a GELU activation function layer and a second fully connected layer. An input of the first FC module is connected to an external input and an output of the fourth FC module is summed with an input of a previous layer of the FFN sub-block as the output.

Step 3: with reference to the overall network structure diagram shown in FIG. 2, constructing the improved YOLOv9 model for detecting the pavement disease, specifically including: for the head network of the YOLOv9 model, adding the LSKNet module after a 16th, 19th, and 22nd RepNCSPELAN4 modules, and for the backbone network of the YOLOv9 model, adding the LSKNet module before a 11th SPPELAN module, to obtain the improved YOLOv9 model for detecting the pavement disease.

Referring to the schematic diagram of the LSK selectivity mechanism module shown in FIG. 4, the LSK attention mechanism is added to the residual network as described above, which can help the network better learn and utilize the key information in the input data, thus enhancing the expression ability of the features, and can also improve the flexibility and adaptability of the network, and can dynamically adjust the weights of the features according to the characteristics of the input, so that the network is more flexible to adapt to different input data. Adding the LSK attention mechanism before the feature pyramid network can help the model to better fuse features of different scales.

Step 4: training the pavement disease detection model constructed in step 3, inputting the training set and the validation set from the data set of step 1 into the constructed improved YOLOv9 model for detecting the pavement disease for training to obtain the trained model;

Step 5: evaluating the model, evaluating a detection accuracy of the model according to the improved YOLOv9 model for detecting the pavement disease obtained after training;

Step 6: inputting the to-be-detected pavement disease image into the trained and improved YOLOv9 model for detecting the pavement disease for recognizing the pavement disease, to obtain the detection result, with reference to the schematic diagram of the detection result of the pavement disease shown in FIG. 6.

The content involved in the above embodiments is described below in connection with a preferred embodiment.

The application scenario of the present application is as follows: most of the highways in China are asphalt pavements, and due to factors such as their own large voids, poor stability, and excessive traffic load, etc., the pavement is prone to cracks, depressions, and other diseases, and it is necessary to detect the pavement diseases during the process of road maintenance, so that it can be repaired and maintained. The main content of the present application is the study of the detection algorithm of the pavement disease based on the YOLOv9 model, and the optimization of the existing detection network, so that it can have a higher accuracy of detecting the disease.

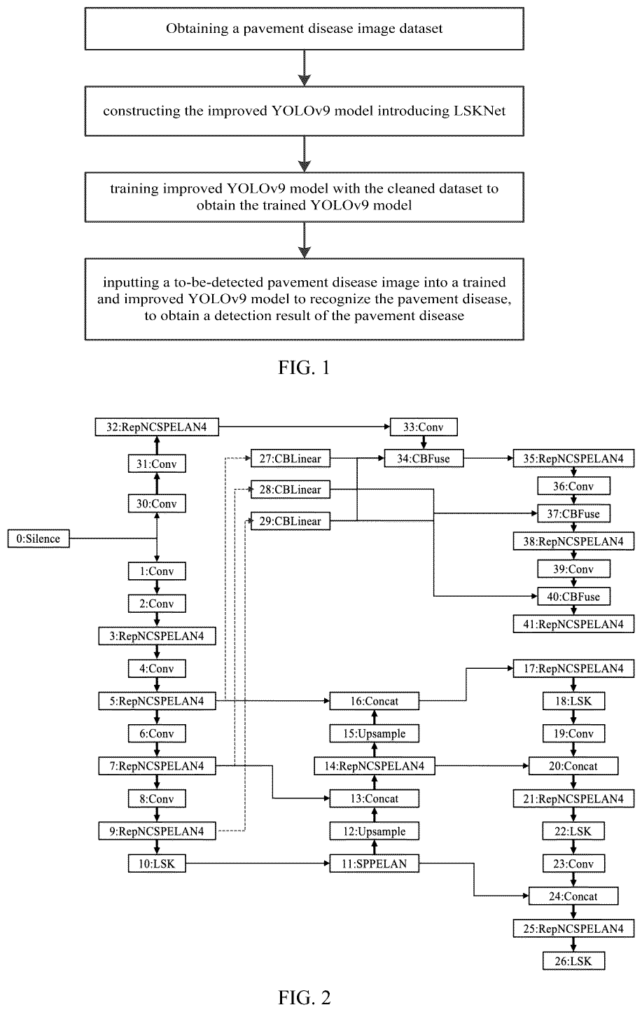

As shown in FIG. 1, which clearly demonstrates a flowchart of a pavement disease detection method based on the improved YOLOv9 model provided by the present application, which includes:

Step 1: obtaining a pavement disease image dataset and dividing the pavement disease image dataset into a training set, a validation set and a test set.

In step 1, the obtained pavement disease image dataset may be a publicly available dataset or a dataset that is labeled after being collected by person, and the dataset should contain pavement disease images with labeled information, which can be used in the training stage of the subsequent improved YOLOv9 model. The data used in the present application is derived from the RDD2020 competition dataset.

When the publicly available dataset is selected, a pre-processing operation of the data should be performed on the dataset, including:

Step 1.1: the RDD2020 competition dataset selected for the present application contains multiple categories of pavement diseases, but four of which the present application focuses only on, namely Longitudinal Cracks (D00), Transverse Cracks (D10), Alligator Cracks (D20), and Potholes (D40). The data is also cleaned to remove unlabeled images and images that do not contain any of the above four categories, which effectively improves the generalization ability and robustness of the model.

Step 1.2: dividing the dataset into the training set, the validation set and the test set according to the ratio of 8:1:1. The divided training set is used as the training data for the subsequent improved YOLOv9 model.

Step 2: constructing the LSKNet module. Referring to the schematic structural diagram of the LSKNet module shown in FIG. 3, the module includes a large kernel selection module and a feed-forward network module;

The large kernel selection module dynamically adjusts the sensory field of the network as needed, consists of a fully connected layer sequence (FC), a GELU activation function layer, a core LSK layer, and a second fully connected layer. An input of the first FC module is connected to an external input, and an output of the fourth FC module is summed with an input of a previous layer of the LK Selection sub-block as the output.

This module constructs larger kernel convolutions by explicitly decomposing them into sequences of depth convolutions with large growing kernels and increasing expansion. Specifically, for the ith deep convolution with kernel size k and expansion rate d, the expression for the feeling field RF is shown in Eqs. (1) (2):

$${k}_{i - 1} \leq {k}_{i} ; {d}_{1} = 1 , {d}_{i - 1} < {d}_{i} \leq R {F}_{i - 1} , \qquad ( 1 )$$

$$R {F}_{1} = {k}_{1} , R {F}_{i} = {d}_{i} ( {k}_{i} - 1 ) + R {F}_{i - 1} . \qquad ( 2 )$$

The increase of a size of the kernel and an expansion rate ensures that the expansion of the sensory field is fast enough, and the LSKNet module sets an upper limit on the expansion rate to ensure that the expansion convolution does not introduce gaps between feature maps. For example, it is possible to decompose a large kernel into 2 or 3 deep convolutions, and the design thus proposed has two advantages. First, it explicitly produces multiple features with different large sensory fields, which makes later kernel selection easier. Second, sequential decomposition is more efficient than simply applying a single larger kernel. Under the same theoretical sensory fields, such decomposition greatly reduces the number of parameters compared to a standard large convolution kernel.

In order to obtain features with rich contextual information for different ranges of input X, a series of decomposed deep convolutions with different sensory fields are applied:

$${U}_{0} = X , {U}_{i + 1} = {ℱ}_{i}^{d w} ( {U}_{i} ) , \qquad ( 3 )$$

### Where

$${ℱ}_{i}^{d w} ( \cdot )$$

is a deep convolution with a kernel kᵢ and expansion dᵢ. N decomposition kernels are assumed and each kernel is further processed by a 1×1 convolutional layer [symbol] ^{1×1}(⋅):

$${\tilde{U}}_{i} = {ℱ}_{i}^{1 \times 1} ( {U}_{i} ) , for i in [ 1 , N ] , \qquad ( 4 )$$

Channel mixing is allowed for each spatial feature vector.

The feed-forward network module is configured for channel mixing and feature refinement, and consists of a sequence of fully connected layers (FC), deep convolution, a GELU activation function layer and a second fully connected layer. An input of the first FC module is connected to an external input and an output of the fourth FC module is summed with an input of a previous layer of the FFN sub-block as the output.

Step 3: constructing the improved YOLOv9 model for detecting the pavement disease, specifically including: for the head network of the YOLOv9 model, adding the LSKNet module after the RepNCSPELAN4 module at the 16th, 19th, and 22nd layers, respectively, and for the backbone network of the YOLOv9 model, adding the LSKNet module before the SPPELAN module at the 11th layer, to obtain the improved YOLOv9 model for detecting the pavement disease model.

The LSK attention mechanism is added to the residual network as described above, which can help the network better learn and utilize the key information in the input data, thus enhancing the expression ability of the features, and can also improve the flexibility and adaptability of the network, and can dynamically adjust the weights of the features according to the characteristics of the input, so that the network is more flexible to adapt to different input data. Adding the LSK attention mechanism before the feature pyramid network can help the model to better fuse features of different scales.

Referring to the schematic of the LSK selectivity mechanism module in FIG. 4, the mechanism explicitly relies on a series of large kernels through decomposition, which is different from most existing attention-based methods. Second, the method adaptively aggregates information from large kernels in the spatial dimension rather than utilizing the channel dimension. This design is more intuitive and effective because channel selection cannot model the variance of different targets in image space.

Step 4: training the constructed improved YOLOv9 model for detecting the pavement disease constructed in Step 3.

The training parameters are set, the batch size is set to 16, yolov9-c is used as the initialization weights, and the number of training rounds is set to 200.

The positive and negative sample matching strategy used in the training is TaskAlign sample matching, and the matching strategy of TaskAlignedAssigner is to select positive samples based on the scores weighted by the scores of classification and regression.

$$t = {s}^{a} * {u}^{b} \qquad ( 5 )$$

For each t, s is the classification confidence of the category t corresponding to each anchor point, u is the IoU of each anchor point on the predicted target border with t, a, b denote the indices of the external configurations, which can be multiplied to measure the degree of alignment alignment metrics, and then directly based on the degree of alignment to select the topk as a positive sample.

A composite loss function is used in training, which combines the classification loss BCE Loss, regression loss DFL Loss and CIOU Loss. The BCELoss loss function is:

$${L}_{B C E} ( y , {y}^{′} ) = - \frac{1}{n} {\sum }_{i = 1}^{n} [ {y}_{i} log ( {y}_{i}^{′} ) + ( 1 - {y}_{i} ) log ( 1 - {y}_{i}^{′} ) ] \qquad ( 6 )$$

Where L_{BCE}(y,y′) is the binary crossover upper loss on the entire dataset; n is the number of samples; yᵢ is an actual label of the ith sample, which is usually 0 or 1 (indicating one of two categories); and yᵢ′ is a probability predicted by the model for the ith sample, which is usually between 0 and 1.

The DFL Loss loss function is as follows:

$${L}_{D F L} ( {y}_{i} , {y}_{i + 1} ) = - ( i + 1 - y ) log ( {y}_{i} ) - ( y - i ) log ( {y}_{i + 1} ) \qquad ( 7 )$$

Where y is the actual label and the variables in the equation satisfy i≤y≤i+1(i), [0,1.0].

The CIoU Loss loss function is as follows:

$$DIoU = IoU - ( \frac{{ρ}^{2} ( b , {b}^{gt} )}{{c}^{2}} + α v ) \qquad ( 8 )$$

$$v = \frac{4}{{π}^{2}} {( arctan \frac{{w}^{g t}}{{h}^{g t}} - arctan \frac{w}{h} )}^{2} \qquad ( 9 )$$

$$α = \frac{v}{( 1 - IoU ) + v} \qquad ( 10 )$$

Where (w^{gt}, h^{gt}), (w, h) denote a width and a height of the actual border and a predicted border, respectively, and further, the CIoU Loss is denoted as:

$${L}_{DIoU} = 1 - CIoU \qquad ( 11 )$$

The training set and the validation set in step 1 are put into the constructed improved YOLOv9 model for detecting the pavement disease according to the set training parameters and processing methods, to obtain the network model with good convergence.

Step 5: evaluating the model. According to the improved YOLOv9 model for detecting the pavement disease obtained after training, the original YOLOv9 network is compared with the improved YOLOv9 network through the evaluation indexes such as detection accuracy, return rate, and average accuracy, and the results show that the improved YOLOv9 network is better in pavement disease detection, and the results are shown in Tables 1 and 2, the Table 1 shows the detection results of the original YOLOv9 , and the Table 2 shows the detection results of the improved YOLOv9 network.

TABLE 1
detection results of the original YOLOv9 model

| metrics/precision | metrics/recall | metrics/mAP_0.5 |
|---|---|---|
| 0.61651 | 0.52644 | 0.55632 |

TABLE 2
detection results of improved YOLOv9 model

| metrics/precision | metrics/recall | metrics/mAP_0.5 |
|---|---|---|
| 0.6238 | 0.52083 | 0.56358 |

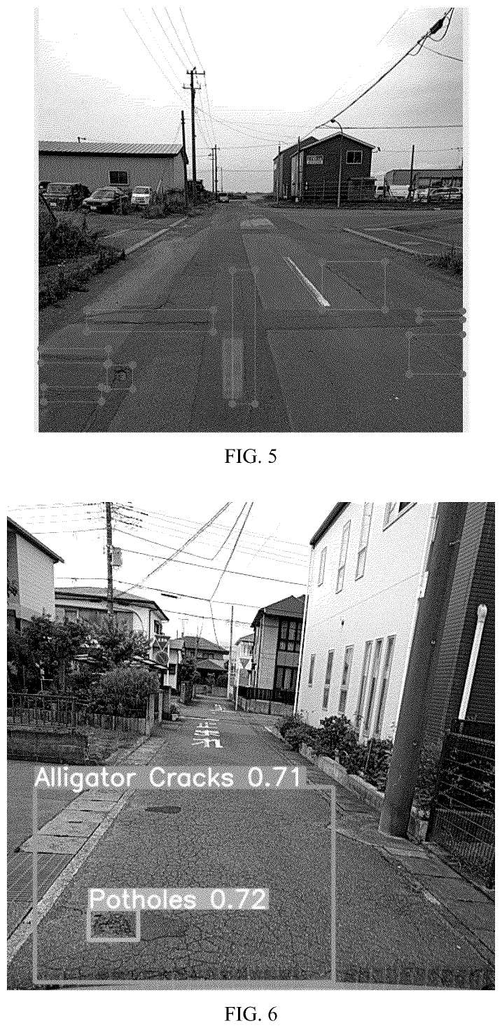

Step 6: as shown in FIG. 5, inputting the to-be-detected pavement disease images into the trained and improved YOLOv9 model for detecting the pavement disease to recognize the pavement disease, to the pavement disease detection image shown in FIG. 6, as shown in FIG. 6, the disease detection image contains the category of each image, and the disease is labeled with a rectangular box in the disease detection image, and a confidence level is labeled.

In summary, the embodiment described in the present application provides a pavement disease detection method based on the improved YOLOv9. Firstly, a pavement dataset is obtained, the public dataset is subjected to data cleansing, and the dataset is divided into a training set, a validation set, and a test set according to a ratio of 8:1:1. Secondly, in a head network of the YOLOv9 model, the LSKNet module is added after the 16th, 19th, and 22nd layers, respectively, of the RepNCSPELAN4 module, so that the network can better learn and utilize the key information in the input data, thus enhancing the expression ability of the features; next, the LSKNet module is added before the 11th layer of SPPELAN in the backbone network, so that the model can better learn and utilize the key information in the input data, thus enhancing the expression ability of the features. Subsequently, the constructed YOLOv9 model is trained to obtain a model with higher accuracy compared to the original YOLOv9 network. Finally, the trained and improved YOLOv9 model for detecting the pavement disease model is utilized to detect to-be-detected pavement image, to obtain the final detection results.

### Second Embodiment

This embodiment provides a pavement disease detection device based on the improved YOLOv9 model, which includes:
A detection module for inputting the to-be-detected pavement disease image into the trained and improved YOLOv9 model for detecting the pavement disease for recognizing the pavement disease to obtain the detection result;

In the detection module, the training method of the improved pavement disease model based on the YOLOv9 model, comprising:
obtaining a pavement disease image dataset and dividing the pavement disease image dataset into a training set and a validation set;
adding an LSKNet module after a specific layer of an original YOLOv9 model to construct the improved YOLOv9 model for detecting the pavement disease; and
training the constructed improved YOLOv9 model for detecting the pavement disease by the training set and the validation set to obtain the trained and improved YOLOv9 model for detecting the pavement disease.

### Third Embodiment

This embodiment provides a computer-readable storage medium, on which a computer program is stored, the program, when executed by a processor implements the steps of the method described in any one of the first embodiment.

The foregoing is only a preferred embodiment of the present application, and it should be noted that for those skilled in the art, several improvements and deformations can be made without departing from the technical principles of the present application, and these improvements and deformations should also be regarded as the scope of the present application.

It should be appreciated by those skilled in the art that embodiments of the present application may be provided as methods, systems or computer program products. Thus, the present application may take the form of a fully hardware embodiment, a fully software embodiment, or an embodiment that combines software and hardware. Further, the present application may take the form of a computer program product implemented on one or more computer-usable storage medium (including, but not limited to, disk memory, CD-ROM, optical memory, etc.) that contain computer-usable program code therein.

The present application is described with reference to flowcharts and/or block diagrams of methods, devices (systems), and computer program products according to embodiments of the present application. It is to be understood that each of the processes and/or boxes in the flowcharts and/or block diagrams and the combination of processes and/or boxes in the flowcharts and/or block diagrams may be implemented by computer program instructions. These computer program instructions may be provided to a processor of a general-purpose computer, a special-purpose computer, an embedded processor, or other programmable data-processing device to produce a machine, such that the instructions executed by the processor of the computer or other programmable data-processing device produce a device for carrying out the functions specified in the one flow or multiple flows of the flowchart and/or the one box or multiple boxes of the box diagram.

These computer program instructions may also be stored in computer-readable memory that directs the computer or other programmable data processing device to operate in a particular manner, such that the instructions stored in the computer-readable memory produce an article of manufacture comprising an instruction device that implements the function specified in the one process or processes of the flowchart and/or the one box or boxes of the block diagram.

These computer program instructions may also be loaded onto a computer or other programmable data processing device such that a series of operational steps are performed on the computer or other programmable device to produce computer-implemented processing, such that the instructions executed on the computer or other programmable device provide steps for implementing the functions specified in the one or more processes of the flowchart and/or the one or more boxes of the block diagram.

Finally, it should be noted that the above embodiments are only used to illustrate the technical solutions of the present application rather than to limit the scope of protection thereof, and although the present application has been described in detail with reference to the above embodiments, those skilled in the art should understand that those skilled in the art who reads the present application may still carry out all kinds of changes, modifications, or equivalent substitutions of specific embodiments of the invention, but these changes, modifications, or equivalent substitutions, are all within the scope of the present disclosure. However, these changes, modifications or equivalent substitutions are within the scope of the claims to be approved.

What is claimed is:

1. A pavement disease detection method based on an improved YOLOv9 model, comprising:
inputting a to-be-detected pavement disease image into a trained and improved YOLOv9 model for detecting a pavement disease to recognize the pavement disease, to obtain a detection result;
wherein a training method of the improved YOLOv9 model for detecting the pavement disease comprises:
obtaining a pavement disease image dataset and dividing the pavement disease image dataset into a training set and a validation set;
adding an LSKNet module after a specific layer of an original YOLOv9 model to construct the improved YOLOv9 model for detecting the pavement disease; and
training the constructed improved YOLOv9 model for detecting the pavement disease by the training set and the validation set to obtain the trained and improved YOLOv9 model for detecting the pavement disease.

2. The improved pavement disease detection method based on the YOLOv9 model according to claim 1, wherein the LSKNet module is added after the specific layer of the original YOLOv9 model to construct the improved YOLOv9 model for detecting the pavement disease comprises:
constructing an LSKNet module, wherein the LSKNet module comprises a large kernel (LK) selection module, and a feed-forward network (FFN) module, wherein the LK selection module is capable of dynamically adjusting a sensory field of a network as needed, and the FFN module is configured for channel mixing and feature refinement;
adding the LSKNet module after a 16th, 19th, and 22nd RepNCSPELAN4 modules of a head network of the original YOLOv9 model, and adding the LSKNet module before a 11th SPPELAN module of a backbone network of the original YOLOv9 model, to obtain the improved YOLOv9 model for detecting the pavement disease.

3. The pavement disease detection method based on the improved YOLOv9 model according to claim 2, wherein the LK selection module comprises a sequence of fully connected layers, a gaussian error linear unit (GELU) activation function layer, a core LSK layer, and a second fully connected layer.

4. The pavement disease detection method based on the improved YOLOv9 model according to claim 2, wherein the FFN module comprises a sequence of fully connected layers, a depth convolution, a GELU activation function layer, and a second fully connected layer.

5. The pavement disease detection method based on the improved YOLOv9 model according to claim 1, wherein the pavement disease image dataset is derived from the RDD2020 competition dataset.

6. The pavement disease detection method based on the improved YOLOv9 model according to claim 1, wherein the pavement disease image dataset comprises a plurality of categories of pavement diseases, namely Longitudinal Cracks (D00), Transverse Cracks (D10), Alligator Cracks (D20), and Potholes (D40).

7. The pavement disease detection method based on the improved YOLOv9 model according to claim 1, wherein the detection result comprises types and location information of the pavement disease.

8. The pavement disease detection method based on the improved YOLOv9 model according to claim 1, wherein the method further comprises: dividing the test set from the pavement disease image dataset, and evaluating a detection accuracy of the trained and improved YOLOv9 model for detecting the pavement disease by the test set.

9. A pavement disease detection device based on an improved YOLOv9 model, comprising:
a detection module, configured for inputting a to-be-detected pavement disease image into a trained and improved YOLOv9 model for detecting a pavement disease to recognize the pavement disease, to obtain a detection result;
Wherein in the detection module, a training method of the improved YOLOv9 model for detecting the pavement disease comprises:
obtaining a pavement disease image dataset and dividing the pavement disease image dataset into a training set and a validation set;
adding an LSKNet module after a specific layer of an original YOLOv9 model to construct the improved YOLOv9 model for detecting the pavement disease; and
training the constructed improved YOLOv9 model for detecting the pavement disease by the training set and the validation set to obtain the trained and improved YOLOv9 model for detecting the pavement disease.

10. A computer-readable storage medium, on which a computer program is stored, wherein the program, when executed by a processor, implements the method described in claim 1.
